(19) United States
(12) Patent Application Publication
(10) Pub. No.: US 2010/0302365 A1
(43) Pub. Date: Dec. 2, 2010

(54) Depth Image Noise Reduction

(75) Inventors: Mark J. Finocchio, Redmond, WA (US); Ryan Michael Geiss, San Jose, CA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/475,074

(22) Filed: May 29, 2009

(51) Int. Cl. H04N 7/18

(52) U.S. Cl. 348/142; 348/E07.085

(57) ABSTRACT

A depth image of a scene may be received, observed, or captured by a device. The depth image may then be analyzed to determine whether the depth image includes noise. For example, the depth image may include one or more holes having one or more empty pixels or pixels without a depth value. Depth values for the one or more empty pixels may be estimated and a depth image that includes the estimated depth values for the one or empty more pixels may be rendered.

### BACKGROUND

Many computing applications such as computer games, multimedia applications, or the like use controls to allow users to manipulate game characters or other aspects of an application. Typically such controls are input using, for example, controllers, remotes, keyboards, mice, or the like. Unfortunately, such controls can be difficult to learn, thus creating a barrier between a user and such games and applications. Furthermore, such controls may be different than actual game actions or other application actions for which the controls are used. For example, a game control that causes a game character to swing a baseball bat may not correspond to an actual motion of swinging the baseball bat.

### SUMMARY

Disclosed herein are systems and methods for processing depth information of a scene that may be used to interpret human input. For example, a first depth image of a scene may be received, captured, or observed. The first depth image may then be analyzed to determine whether the first depth image includes noise. For example, the first depth image may include one or more holes having one or more empty pixels or pixels without a depth value. According to an example embodiment, depth values for the one or more empty pixels may be estimated. A second depth image that may include valid depth values from the first depth image and the estimated depth values for the one or empty more pixels may then be rendered. In one embodiment, the second depth image may be processed to, for example, determine whether the second depth image includes a human target and to generate a model of the human target that may be tracked to, for example, animate an avatar and/or control various computing applications.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A and 1B illustrate an example embodiment of a target recognition, analysis, and tracking system with a user playing a game.

FIG. 2 illustrates an example embodiment of a capture device that may be used in a target recognition, analysis, and tracking system.

FIG. 3 illustrates an example embodiment of a computing environment that may be used to interpret one or more gestures in a target recognition, analysis, and tracking system.

FIG. 4 illustrates another example embodiment of a computing environment that may be used to interpret one or more gestures in a target recognition, analysis, and tracking system.

FIG. 5 depicts a flow diagram of an example method for processing depth information including a depth image.

FIG. 6 illustrates an example embodiment of a depth image that may be captured.

FIGS. 7A and 7B illustrate an example embodiment of a portion of a depth image.

FIGS. 8A-8C illustrate an example embodiment of depth values being estimated for empty pixels in a portion of a depth image.

FIGS. 9A-9D illustrate an example embodiment of a depth image that may have a limit on a number of empty pixels for which a depth value may be estimated.

FIG. 10 illustrates an example embodiment of a depth image that may be rendered having depth values estimated for noise.

### DETAILED DESCRIPTION OF ILLUSTRATIVE EMBODIMENTS

As will be described herein, a user may control an application executing on a computing environment such as a game console, a computer, or the like by performing one or more gestures. According to one embodiment, the gestures may be received by, for example, a capture device. For example, the capture device may capture a depth image of a scene. In one embodiment, the depth image may include noise. The noise may include a hole having one or more empty pixels or pixels without depth values. According to an example embodiment, depth values may be estimated for the empty pixels and a depth image may be rendered that includes the estimated depth values for the noise. The rendered depth image may then be processed to, for example, determine whether the rendered depth image includes a human target and to generate a model of the human target may be generated. According to an example embodiment, the model may be tracked, an avatar associated with the model may be rendered, and/or one or more applications executing on a computer environment may be controlled.

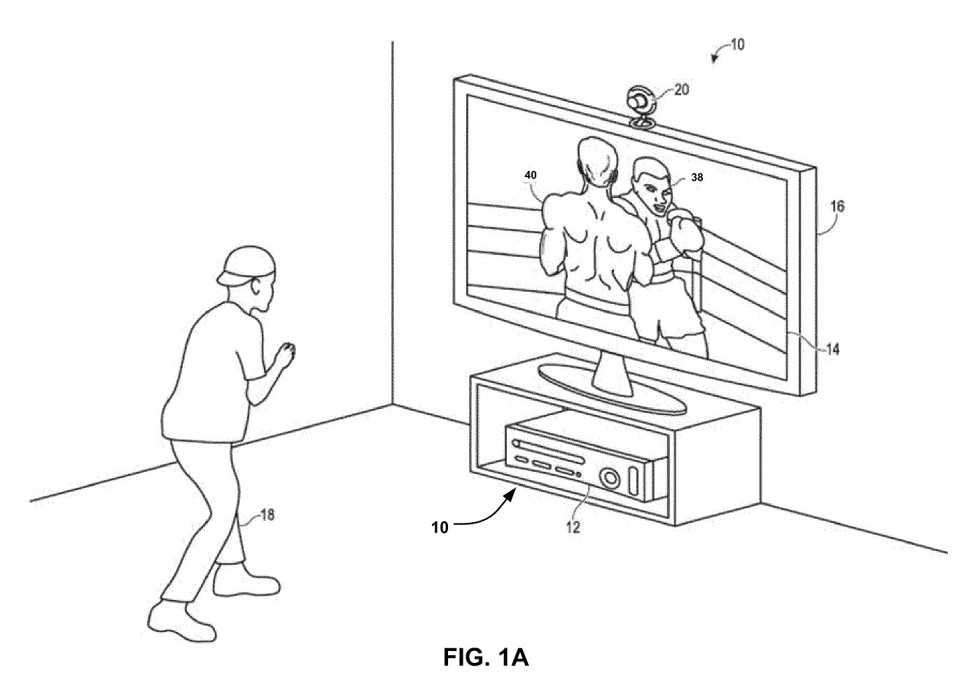

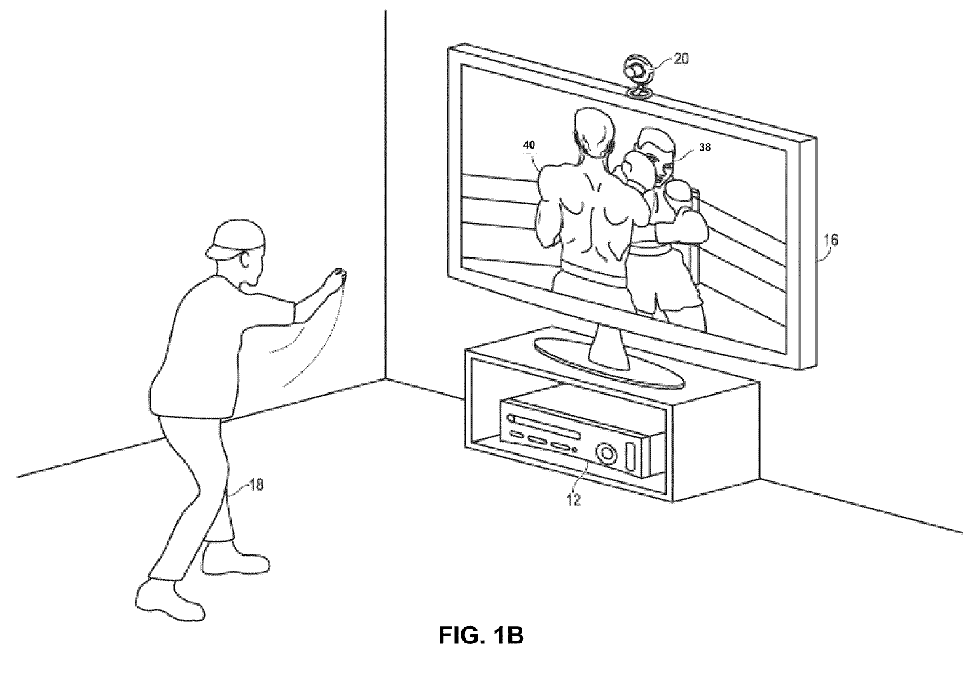

FIGS. 1A and 1B illustrate an example embodiment of a configuration of a target recognition, analysis, and tracking system 10 with a user 18 playing a boxing game. In an example embodiment, the target recognition, analysis, and tracking system 10 may be used to recognize, analyze, and/or track a human target such as the user 18.

As shown in FIG. 1A, the target recognition, analysis, and tracking system 10 may include a computing environment 12. The computing environment 12 may be a computer, a gaming system or console, or the like. According to an example embodiment, the computing environment 12 may include hardware components and/or software components such that the computing environment 12 may be used to execute applications such as gaming applications, non-gaming applications, or the like. In one embodiment, the computing environment 12 may include a processor such as a standardized processor, a specialized processor, a microprocessor, or the like that may execute instructions including, for example, instructions for receiving a depth image, determining whether a depth image includes noise, estimating depth values for pixels associated with noise, rendering depth images that include the estimated depth values for the pixels associated with the noise, or any other suitable instruction, which will be described in more detail below.

As shown in FIG. 1A, the target recognition, analysis, and tracking system 10 may further include a capture device 20. The capture device 20 may be, for example, a camera that may be used to visually monitor one or more users, such as the user 18, such that gestures performed by the one or more users may be captured, analyzed, and tracked to perform one or more controls or actions within an application, as will be described in more detail below.

According to one embodiment, the target recognition, analysis, and tracking system 10 may be connected to an audiovisual device 16 such as a television, a monitor, a high-definition television (HDTV), or the like that may provide game or application visuals and/or audio to a user such as the user 18. For example, the computing environment 12 may include a video adapter such as a graphics card and/or an audio adapter such as a sound card that may provide audiovisual signals associated with the game application, non-game application, or the like. The audiovisual device 16 may receive the audiovisual signals from the computing environment 12 and may then output the game or application visuals and/or audio associated with the audiovisual signals to the user 18. According to one embodiment, the audiovisual device 16 may be connected to the computing environment 12 via, for example, an S-Video cable, a coaxial cable, an HDMI cable, a DVI cable, a VGA cable, or the like.

As shown in FIGS. 1A and 1B, the target recognition, analysis, and tracking system 10 may be used to recognize, analyze, and/or track a human target such as the user 18. For example, the user 18 may be tracked using the capture device 20 such that the movements of user 18 may be interpreted as controls that may be used to affect the application being executed by computer environment 12. Thus, according to one embodiment, the user 18 may move his or her body to control the application.

As shown in FIGS. 1A and 1B, in an example embodiment, the application executing on the computing environment 12 may be a boxing game that the user 18 may be playing. For example, the computing environment 12 may use the audiovisual device 16 to provide a visual representation of a boxing opponent 38 to the user 18. The computing environment 12 may also use the audiovisual device 16 to provide a visual representation of a player avatar 40 that the user 18 may control with his or her movements. For example, as shown in FIG. 1B, the user 18 may throw a punch in physical space to cause the player avatar 40 to throw a punch in game space. Thus, according to an example embodiment, the computer environment 12 and the capture device 20 of the target recognition, analysis, and tracking system 10 may be used to recognize and analyze the punch of the user 18 in physical space such that the punch may be interpreted as a game control of the player avatar 40 in game space.

Other movements by the user 18 may also be interpreted as other controls or actions, such as controls to bob, weave, shuffle, block, jab, or throw a variety of different power punches. Furthermore, some movements may be interpreted as controls that may correspond to actions other than controlling the player avatar 40. For example, the player may use movements to end, pause, or save a game, select a level, view high scores, communicate with a friend, etc. Additionally, a full range of motion of the user 18 may be available, used, and analyzed in any suitable manner to interact with an application.

In example embodiments, the human target such as the user 18 may have an object. In such embodiments, the user of an electronic game may be holding the object such that the motions of the player and the object may be used to adjust and/or control parameters of the game. For example, the motion of a player holding a racket may be tracked and utilized for controlling an on-screen racket in an electronic sports game. In another example embodiment, the motion of a player holding an object may be tracked and utilized for controlling an on-screen weapon in an electronic combat game.

According to other example embodiments, the target recognition, analysis, and tracking system 10 may further be used to interpret target movements as operating system and/or application controls that are outside the realm of games. For example, virtually any controllable aspect of an operating system and/or application may be controlled by movements of the target such as the user 18.

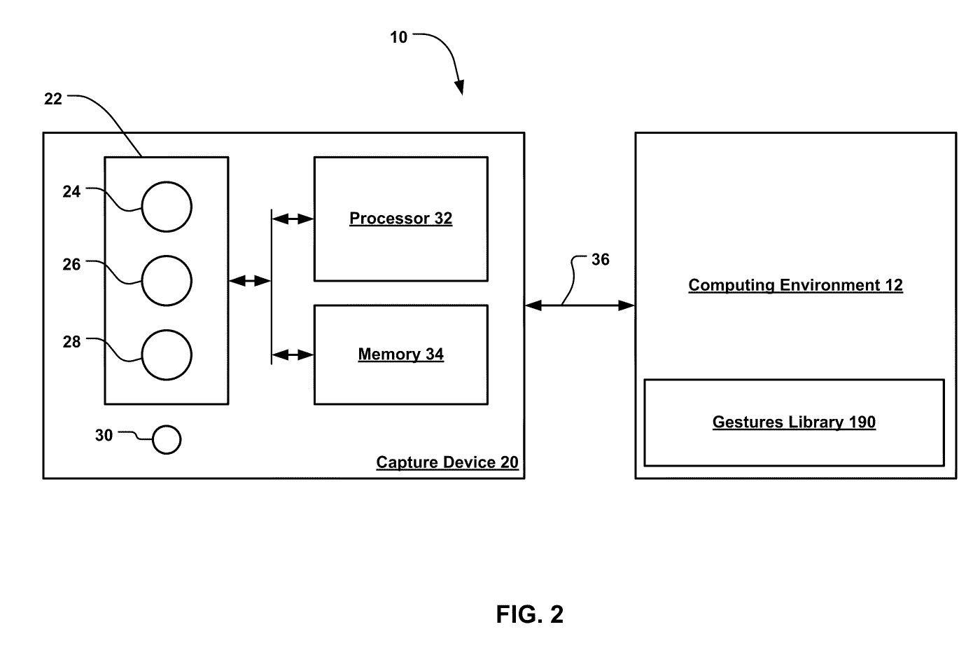

FIG. 2 illustrates an example embodiment of the capture device 20 that may be used in the target recognition, analysis, and tracking system 10. According to an example embodiment, the capture device 20 may be configured to capture video with depth information including a depth image that may include depth values via any suitable technique including, for example, time-of-flight, structured light, stereo image, or the like. According to one embodiment, the capture device 20 may organize the depth information into “Z layers,” or layers that may be perpendicular to a Z axis extending from the depth camera along its line of sight.

As shown in FIG. 2, the capture device 20 may include an image camera component 22. According to an example embodiment, the image camera component 22 may be a depth camera that may capture the depth image of a scene. The depth image may include a two-dimensional (2-D) pixel area of the captured scene where each pixel in the 2-D pixel area may represent a depth value such as a length or distance in, for example, centimeters, millimeters, or the like of an object in the captured scene from the camera.

As shown in FIG. 2, according to an example embodiment, the image camera component 22 may include an IR light component 24, a three-dimensional (3-D) camera 26, and an RGB camera 28 that may be used to capture the depth image of a scene. For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28. In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, the capture device 20 may use a structured light to capture depth information. In such an analysis, patterned light (i.e., light displayed as a known pattern such as grid pattern or a stripe pattern) may be projected onto the scene via, for example, the IR light component 24. Upon striking the surface of one or more targets or objects in the scene, the pattern may become deformed in response. Such a deformation of the pattern may be captured by, for example, the 3-D camera 26 and/or the RGB camera 28 and may then be analyzed to determine a physical distance from the capture device to a particular location on the targets or objects.

According to another embodiment, the capture device 20 may include two or more physically separated cameras that may view a scene from different angles to obtain visual stereo data that may be resolved to generate depth information.

The capture device 20 may further include a microphone 30. The microphone 30 may include a transducer or sensor that may receive and convert sound into an electrical signal. According to one embodiment, the microphone 30 may be used to reduce feedback between the capture device 20 and the computing environment 12 in the target recognition, analysis, and tracking system 10. Additionally, the microphone 30 may be used to receive audio signals that may also be provided by the user to control applications such as game applications, non-game applications, or the like that may be executed by the computing environment 12.

In an example embodiment, the capture device 20 may further include a processor 32 that may be in operative communication with the image camera component 22. The processor 32 may include a standardized processor, a specialized processor, a microprocessor, or the like that may execute instructions including, for example, instructions for receiving a depth image, determining whether a depth image includes noise, estimating depth values for pixels associated with noise, rendering depth images that include the estimated depth values for the pixels associated with the noise, or any other suitable instruction, which will be described in more detail below.

The capture device 20 may further include a memory component 34 that may store the instructions that may be executed by the processor 32, images or frames of images captured by the 3-D camera or RGB camera, or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image capture component 22 and the processor 32. According to another embodiment, the memory component 34 may be integrated into the processor 32 and/or the image capture component 22.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide the depth information and images captured by, for example, the 3-D camera 26 and/or the RGB camera 28, and/or a skeletal model that may be generated by the capture device 20 to the computing environment 12 via the communication link 36. The computing environment 12 may then use the skeletal model, depth information, and captured images to, for example, control an application such as a game or word processor. For example, as shown, in FIG. 2, the computing environment 12 may include a gestures library 190. The gestures library 190 may include a collection of gesture filters, each comprising information concerning a gesture that may be performed by the skeletal model (as the user moves). The data captured by the cameras 26, 28 and the capture device 20 in the form of the skeletal model and movements associated with it may be compared to the gesture filters in the gesture library 190 to identify when a user (as represented by the skeletal model) has performed one or more gestures. Those gestures may be associated with various controls of an application. Thus, the computing environment 12 may use the gestures library 190 to interpret movements of the skeletal model and to control an application based on the movements.

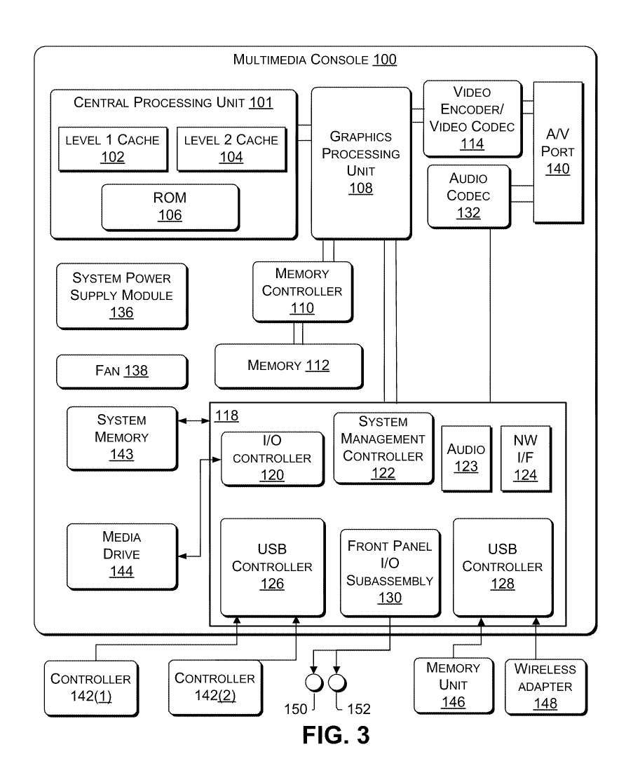

FIG. 3 illustrates an example embodiment of a computing environment that may be used to interpret one or more gestures in a target recognition, analysis, and tracking system. The computing environment such as the computing environment 12 described above with respect to FIGS. 1A-2 may be a multimedia console 100, such as a gaming console. As shown in FIG. 3, the multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The cameras 26, 28 and capture device 20 may define additional input devices for the console 100.

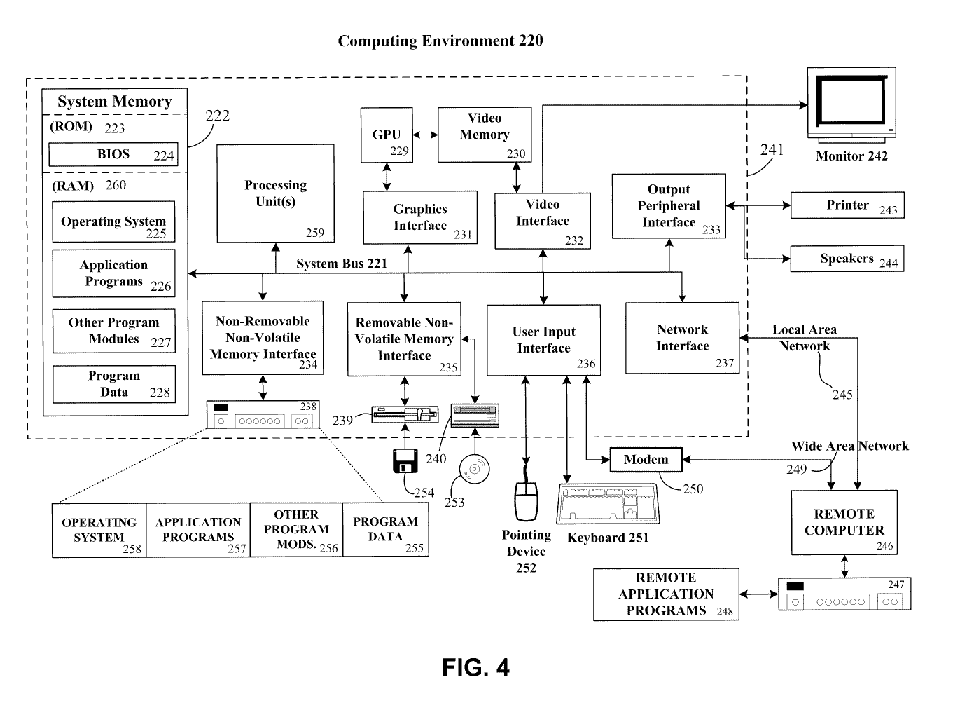

FIG. 4 illustrates another example embodiment of a computing environment 220 that may be the computing environment 12 shown in FIGS. 1A-2 used to interpret one or more gestures in a target recognition, analysis, and tracking system. The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 4, the computing environment 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 4 illustrates operating system 225, application programs 226, other program modules 227, and program data 228.

The computer 241 may also include other removable/non-removable, volatile/nonvolatile computer storage media. By way of example only, FIG. 4 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 4, provide storage of computer readable instructions, data structures, program modules and other data for the computer 241. In FIG. 4, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 26, 28 and capture device 20 may define additional input devices for the console 100. A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 4. The logical connections depicted in FIG. 2 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 4 illustrates remote application programs 248 as residing on memory device 247. It will be appreciated that the network connections shown are exemplary and other means of establishing a communications link between the computers may be used.

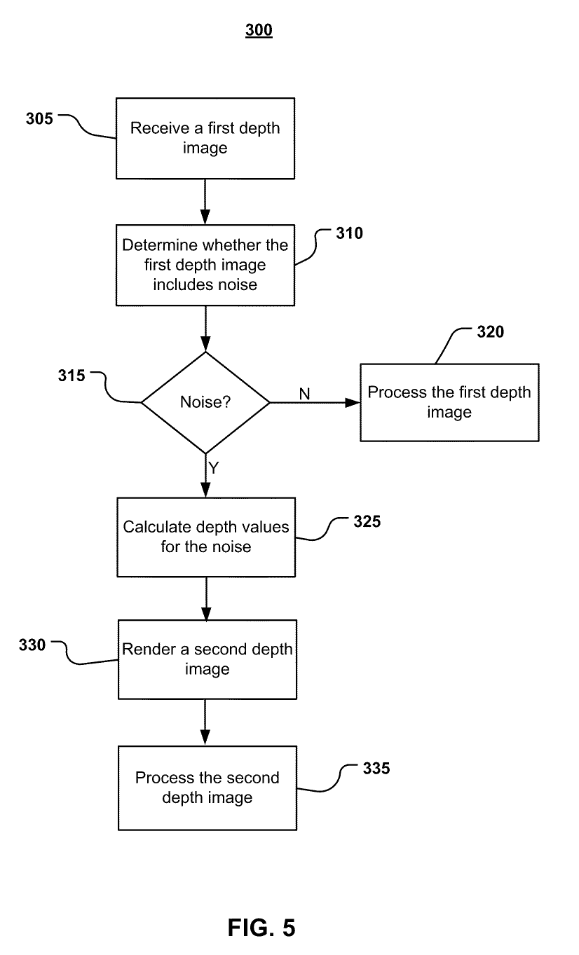

FIG. 5 depicts a flow diagram of an example method 300 for processing depth information including a depth image. The example method 300 may be implemented using, for example, the capture device 20 and/or the computing environment 12 of the target recognition, analysis, and tracking system 10 described with respect to FIGS. 1A-4. In an example embodiment, the example method 300 may take the form of program code (i.e., instructions) that may be executed by, for example, the capture device 20 and/or the computing environment 12 of the target recognition, analysis, and tracking system 10 described with respect to FIGS. 1A-4.

According to one embodiment, at 305, the target recognition, analysis, and tracking system may receive a first depth image. For example, the target recognition, analysis, and tracking system may include a capture device such as the capture device 20 described above with respect to FIGS. 1A-2. The capture device may capture or observe a scene that may include one or more targets or objects. In an example embodiment, the capture device may be a depth camera configured to obtain a depth image of the scene using any suitable technique such as time-of-flight analysis, structured light analysis, stereo vision analysis, or the like.

According to an example embodiment, the first depth image may be a plurality of observed pixels where each observed pixel has an observed depth value. For example, the first depth image may include a two-dimensional (2-D) pixel area of the captured scene where each pixel in the 2-D pixel area may represent a depth value such as a length or distance in, for example, centimeters, millimeters, or the like of an object or target in the captured scene from the capture device.

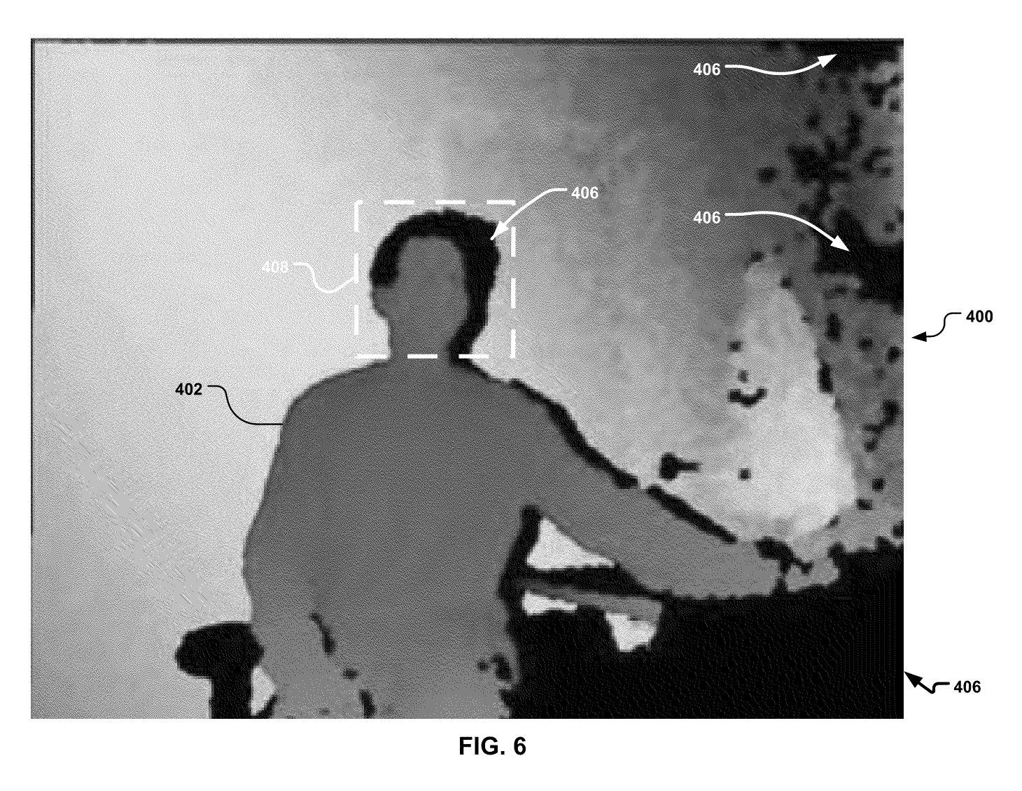

FIG. 6 illustrates an example embodiment of a first depth image 400 that may be received at 305. According to an example embodiment, the first depth image 400 may be an image or frame of a scene captured by, for example, the 3-D camera 26 and/or the RGB camera 28 of the capture device 20 described above with respect to FIG. 2. As shown in FIG. 6, the first depth image 400 may include one or more targets 402 such as a human target, a chair, a table, a wall, or the like in the captured scene. As described above, the first depth image 400 may include a plurality of observed pixels where each observed pixel has an observed depth value associated therewith. For example, the first depth image 400 may include a two-dimensional (2-D) pixel area of the captured scene where each pixel in the 2-D pixel area may represent a depth value such as a length or distance in, for example, centimeters, millimeters, or the like of a target or object in the captured scene from the capture device. In one example embodiment, the first depth image 400 may be colorized such that different colors of the pixels of the depth image correspond to and/or visually depict different distances of the targets 402 from the capture device. For example, according to one embodiment, the pixels associated with a target closest to the capture device may be colored with shades of red and/or orange in the depth image whereas the pixels associated with a target further away may be colored with shades of green and/or blue in the depth image.

Referring back to FIG. 5, at 310, the target recognition, analysis, and tracking system may determine whether the first depth image may include noise. For example, the first depth image that may be captured or observed may be noisy such that the first depth image may include one or more holes. The holes may include areas of the depth image where, for example, the camera may not be able to determine a depth value or a distance to a target or object. For example, according to one embodiment, the holes may include one or more pixels in, for example, the 2-D pixel area of the first depth image that may be empty or may have a depth value of zero. In an example embodiment, the noise may be caused by, for example, shadows from a light source, reflections off an object or target, an edge of a target or object, a background, a color or a pattern of an object or target, or the like.

As shown in FIG. 6, the first depth image 400 may include noise 406. The noise 406 may include one or more holes including one or more empty pixels or pixels without a depth value the first depth image 400. As described above, in one example embodiment, the first depth image 400 may be colorized such that different colors of the pixels of the depth image correspond to and/or visually depict different distances of the targets 402 from the capture device. As shown in FIG. 6, the noise 406 may be colorized black to visually indicate one or more empty pixels or pixels without a depth value.

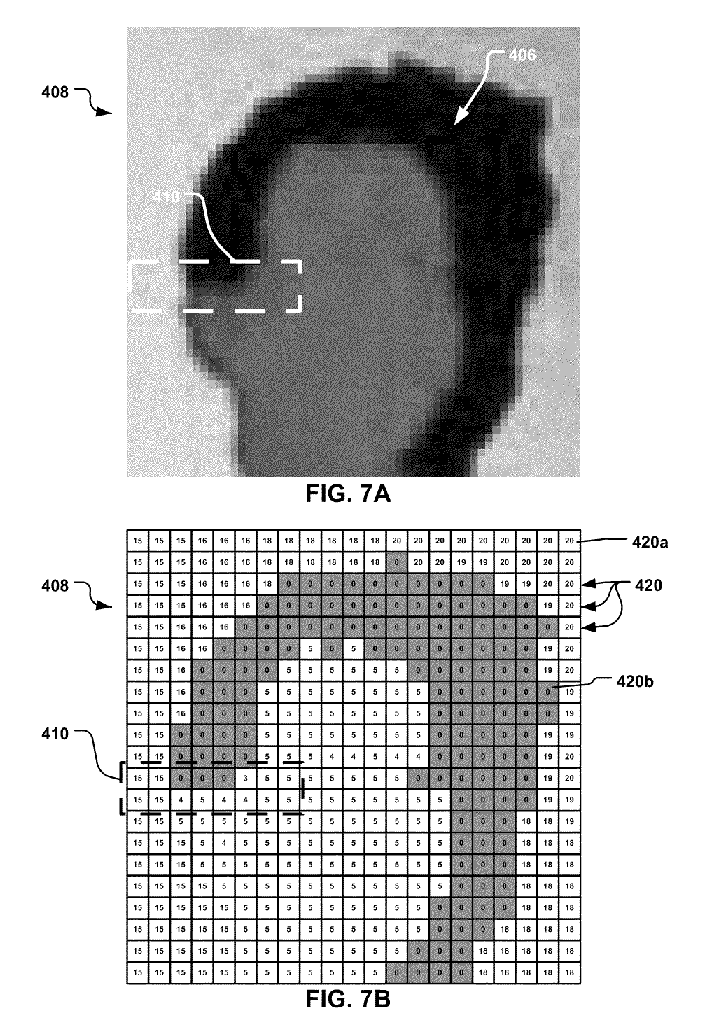

FIGS. 7A and 7B illustrate an example embodiment of a portion 408 of the first depth image 400 shown in FIG. 6. In one embodiment, the portion 408 may be a portion or part of the pixels in the 2-D pixel area of the first depth image 400. For example, as shown in FIG. 7B, the portion 408 may include pixels 420 that may be part of the 2-D pixel area. According to one embodiment, each of the pixels 420 may include a depth value associated therewith. For example, a first pixel 420a may have a depth value of 20 representing the length or distance in, for example, centimeters, millimeters, or the like of a target or object associated with the first pixel 420a from the capture device.

As shown in FIG. 7A, the portion 408 of the first depth image 400 may include noise 406. In an example embodiment, the noise 406 may include a portion of the pixels 420 that have a depth value of 0 as shown in FIG. 7B. For example, a second pixel 420b may have a depth value of 0 indicative that the capture device may not be able to determine a depth value or a distance to the target or object associated with the second pixel 420b.

Referring back to FIG. 5, at 315, if the first depth image does not include noise, the target recognition, analysis, and tracking system may process the first depth image at 320. In one embodiment, the target recognition, analysis, and tracking system may process the first depth image, at 320, such that a model of a human target in the captured scene may be generated. According to an example embodiment, the model may be tracked, an avatar associated with the model may be rendered, and/or one or more applications executing on a computer environment may be controlled, which will be described in more detail below.

At 315, if the first depth image includes noise, the target recognition, analysis, and tracking system may estimate one or more depth values for the noise at 325. For example, a depth value for one or more of the pixels that may be empty or may have a depth value of 0 associated therewith may be estimated at 325.

According to one embodiment, a depth value for an empty pixel may be estimated using neighboring pixels that have a valid depth value. For example, the target recognition, analysis, and tracking system may identify an empty pixel. Upon identifying the empty pixel, the target recognition, analysis, and tracking system may determine whether one or more pixels adjacent to the empty pixel may be valid such that one or more of the adjacent pixels may have a valid, non-zero depth value. If one or more pixels adjacent to the empty pixel may be valid, a depth value for the empty pixel may be generated based on the valid, non-zero depth values of the adjacent pixels.

In an example embodiment, the target recognition, analysis, and tracking system may further track the adjacent pixels having a depth value closest to the capture device, or the smallest, valid depth value, and a depth value farthest from the capture device, or the largest, valid depth value, to generate the depth value for the empty pixel. For example, the target recognition, analysis, and tracking system may identify the adjacent pixels with the smallest, valid non-zero depth value and the largest, valid non-zero depth value. The target recognition, analysis, and tracking system may then determine the difference between those values by, for example, subtracting the largest, valid non-zero depth value and the smallest, valid non-zero depth value of the adjacent pixels.

According to one embodiment, if the difference between the depth value closest to the capture device and the depth value farthest from the capture device may be greater a threshold value, the empty pixel may be assigned the depth value of the adjacent pixel closest to the capture device, or the smallest, valid depth value. If the difference between the depth value closest to the capture device and the depth value farthest from the capture device may be less than the threshold value, the depth values of each of the adjacent, valid pixels may be used to calculate an average depth value. The empty pixel may then be assigned the average depth value.

According to one embodiment, the target recognition, analysis, and tracking system may identify other empty pixels and estimate depth values for those empty pixel as described above until each of the empty pixels in each of the holes may have a depth value associated therewith. Thus, in an example embodiment, the target recognition, analysis, and tracking system may interpolate a value for each of the empty pixels based on neighboring or adjacent pixels that may have a valid depth value associated therewith.

Additionally, in another example embodiment, the target recognition, analysis, and tracking system may estimate depth values for one or more empty pixels in the first depth image based on a depth image of a previous frame of a captured scene. For example, the target recognition, analysis, and tracking system may assign empty pixels in the first depth image to the depth values of the corresponding pixels in the depth image of the previous frame if such pixels have valid depth values.

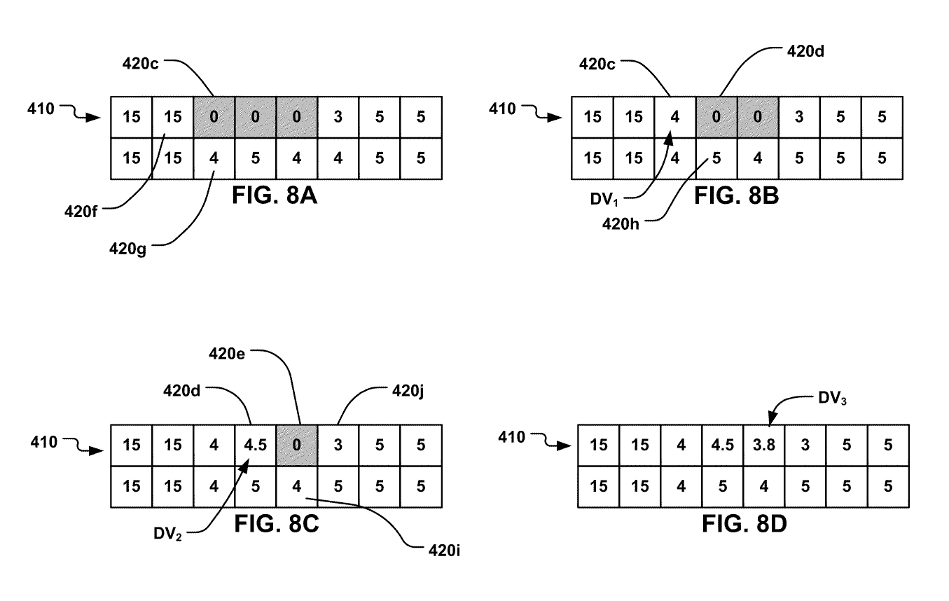

FIGS. 8A-8D illustrate an example embodiment of depth values being generated for empty pixels in a portion 410 of the first depth image 400 shown in FIGS. 7A and 7B. As shown in FIGS. 8A-8D, depth values DV₁, DV₂, and DV₃ for pixels 420c, 420d, and 420e may be generated using neighboring or adjacent pixels with valid depth values. For example, the target recognition, analysis, and tracking system may identify pixel 420c as an empty pixel. Upon identifying pixel 420c as an empty pixel, the target recognition, analysis, and tracking system may determine that pixels 420f and 420g adjacent to pixel 420c may be valid. The target recognition, analysis, and tracking system may then compare the depth value of 15 associated with the pixel 420f and the depth value of 4 associated with the pixel 420g. If the difference between those depth values may be greater than a threshold value, pixel 420c may be assigned the depth value of the adjacent pixel closest to the capture device or having the smallest depth value. If the difference between those depth values may be less than the threshold value, the depth values of pixels 420f and 420g may be used to calculate an average depth value and that may be assigned to pixel 420c. For example, if the threshold value may be a value less than 11, the pixel 420c may be assigned the depth value of 4 associated with the pixel 420g as shown in FIG. 8B.

The target recognition, analysis, and tracking system may then identify pixel 420d as the next empty pixel. Upon identifying pixel 420d as an empty pixel, the target recognition, analysis, and tracking system may determine that pixels 420c and 420h adjacent to pixel 420f may be valid. The target recognition, analysis, and tracking system may then compare the depth value of 4 associated with the pixel 420c and the depth value of 5 associated with the pixel 420h. If the difference between those depth values may be greater than a threshold value, pixel 420d may be assigned the depth value of the adjacent pixel closest to the capture device or having the smallest depth value. If the difference between those depth values may be less than the threshold value, the depth values of pixels 420c and 420h may be used to calculate an average depth value and that may be assigned to pixel 420d. For example, if the threshold value may include a value greater than 1, the values of 4 and 5 associated with pixels 420c and 420h respectively may be averaged to generate a depth value of 4.5 Pixel 420d may then be assigned the averaged depth value of 4.5 as shown in FIG. 8C.

According to an example embodiment, the target recognition, analysis, and tracking system may repeat the process for pixel 420e using, for example, pixels 420d, 420i, and 420j shown in FIG. 8C such that pixel 420e may be assigned a generated depth value of 3.8 (or an average the depth values for 420d, 420i, and 420j) as shown in FIG. 8D. Thus, in one embodiment, the target recognition, analysis, and tracking system may repeat the process until each of the pixels in a hole includes an estimated depth value generated therefor.

In one embodiment, the target recognition, analysis, and tracking system may determine whether to estimate a depth value for an empty pixel at 325. For example, the target recognition, analysis, and tracking system may generate a noise severity value upon determining the first depth image includes noise. The noise severity value may include a ratio of the number of empty pixels or pixels without depth values divided by the total number of pixels in the first depth map. For example, if the depth image includes 50 empty pixels or pixels without a depth value and 100 total pixels, the noise severity value may be 0.5, or 50%.

In an example embodiment, the noise severity value may be used to limit the number of empty pixels in a hole for which to estimate a depth value such that bleeding may be reduced for an object or a target in the depth image. For example, the target recognition, analysis, and tracking system may include a growth value. The growth value may indicative of a number of iterations that may be performed to estimate depth values for empty pixels in a hole of a depth image using neighboring or adjacent pixels. According to one embodiment, the growth value may be a predefined value stored in the target recognition, analysis, and tracking system. For example, the growth value may have a predefined value of 32 such that 32 pixels from each side of a hole that may be adjacent to valid pixels in the depth image may have a depth value estimated therefor. Thus, if a depth image includes a hole that may be a 64×64 pixel square, 32 pixels from the top, bottom, and each of the sides of the square hole may be filled in with estimated depth values such that the each of the empty pixels in the 64×64 square may have a estimated depth value.

Additionally, in an example embodiment, the growth value may be based on, for example, a size of the pixel area associated with the captured depth image. For example, if the target recognition, analysis, and tracking system may capture a depth image that may have a 2-D pixel area of 100×100 pixels, the target recognition, analysis, and tracking system may include a predefined growth value of, for example, 50 based on the depth image having 50 pixels from a top portion to a center of the depth image, 50 pixels from a bottom portion to the center of the depth image, and 50 pixels from each side to the center of the depth image.

According to one embodiment, the target recognition, analysis, and tracking system may adjust the growth value using the noise severity value to limit the number of empty pixels in a hole for which to estimate a depth value such that bleeding may be reduced for an object or a target in the depth image. For example, if the noise severity value may be 50%, the growth value may be reduced by half. Similarly, if the noise severity value may be 75%, the growth value may be reduced by three-fourths. Thus, according to an example embodiment, if the growth value may be 32, the hole may be a 64×64 pixel square, and the noise severity value may be 50%, the growth value may be adjusted to 16 such that 16 pixels from the top, bottom, and each side of the square hole may have a depth value estimated therefor. Similarly, if the growth value may be 32, the hole may be a 64×64 pixel square, and the noise severity value may be 75%, the growth value may be adjusted to 8 such that 8 pixels adjacent the top, bottom, and each of the sides of the square hole may have a depth value estimated therefor.

Depending on the size of a hole and the growth value, in one embodiment, the target recognition, analysis, and tracking system may assign a portion of the pixels in the hole a depth value associated with the background of the depth image. For example, if the growth value is 8, 8 pixels from the top, the bottom, and each of the sides of a 64×64 pixel square may have a depth value estimated therefor as described above. The remaining pixels in the hole 64×64 square may then be assigned a background depth value.

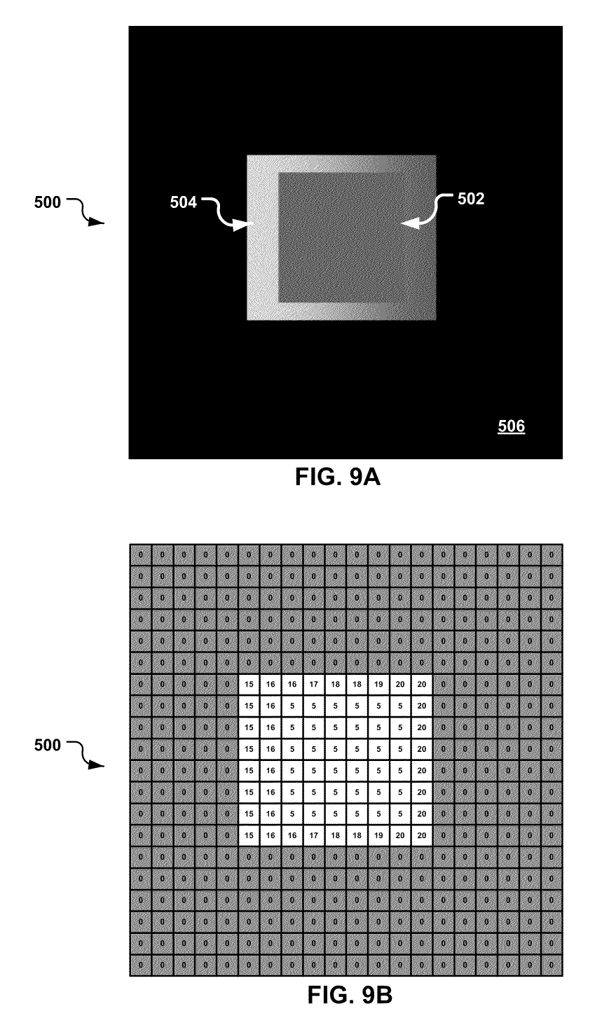

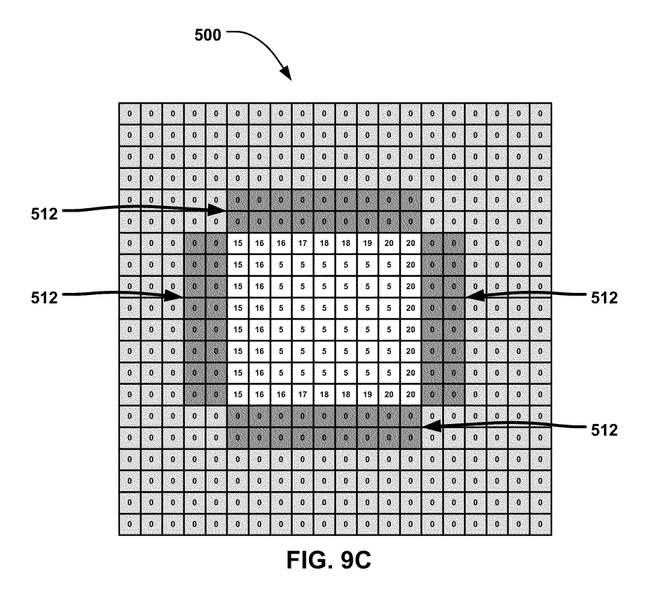

FIGS. 9A-9C illustrate an example embodiment of a depth image 500 that may have a limit on the number of empty pixels for which a depth value may be estimated. According to an example embodiment, the depth image 500 may be an image or frame of a scene captured by, for example, the 3-D camera 26 and/or the RGB camera 28 of the capture device 20 described above with respect to FIG. 2. As shown in FIGS. 9A, the depth image 500 may include noise 506 surrounding one or more targets or objects 502. As described above, the depth image 500 may include a plurality of observed pixels where each observed pixel has an observed depth value associated therewith. For example, the depth image 500 may include a two-dimensional (2-D) pixel area of the captured scene where each pixel in the 2-D pixel area may represent a depth value such as a length or distance in, for example, centimeters, millimeters, or the like of a target or object in the captured scene from the capture device. As shown in FIG. 9B, according to an example embodiment, the depth image 500 may have 400 total pixels of which 336 of those pixels may be empty pixels or pixels without a depth value.

In one embodiment, the target recognition, analysis, and tracking system may generate a noise severity value for the depth image 500. For example, the target recognition, analysis, and tracking system may divide the 336 empty pixels by the 400 total pixels to generate a noise severity value of 0.84, or 84% for the depth image 500 based on the 400 total pixels and the 336 empty pixels.

According to an example embodiment, the target recognition, analysis, and tracking system may adjust a growth value using the generated noise severity value for the depth image 500. For example, in one embodiment, the target recognition, analysis, and tracking system may include an initial growth value of 10 for depth images. Upon determining the depth image 500 includes the noise severity value of 0.84 or 84%, the initial growth value may be reduced by 0.84 to yield an adjusted growth value of 1.6. The adjusted growth value of 1.6 may then be rounded to the nearest whole number of 2.

As described above, the adjusted growth value of 2 may then be used to limit the number of pixels for which to estimate a depth value using neighboring or adjacent pixels. For example, as shown in FIG. 8B, the depth image 500 may include a square of valid pixels surrounded by empty pixels. The target recognition, analysis, and tracking system may limit the number of empty pixels adjacent to each side of the square for which the depth value may be estimated based on the adjusted growth value of 2. For example, as described above, the growth value may be indicative of the number of iterations that may be performed to estimate depth values for empty pixels of a hole that may be adjacent to valid pixels of the depth image. As shown in FIG. 8C, the target recognition, analysis, and tracking system may perform two iterations of calculations for estimated depth values of the empty pixels based on the adjusted growth value of 2 such that depth values for the empty pixels in the portions 512 may be estimated. Each of the portions 512 may include 2 pixels on each side of the valid depth values in the depth image 500. According to an example embodiment, the remaining empty pixels surrounding the portions 512 may be assigned a background depth value.

Referring back to FIG. 5, a second depth image may rendered at 330. For example, in one embodiment, the target recognition, analysis, and tracking system may render a second depth image. The second depth image may be the first depth image received, at 305, with the noise filled in with the depth values estimated at 325.

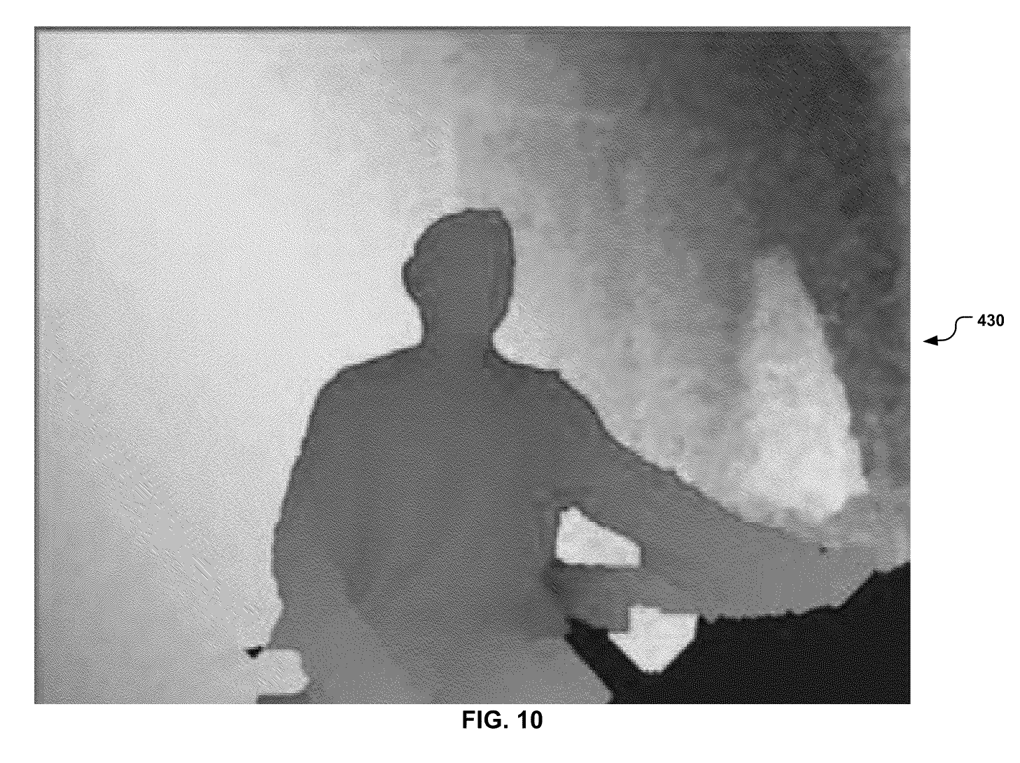

FIG. 10 illustrates an example embodiment of a second depth image 430 that may be rendered at 330. As shown in FIG. 10, the second depth image 430 may be the first depth image 400 shown in FIG. 6 with the noise 406 shown in FIG. 6 filled in with, for example, the depth values estimated at 325.

Referring back to FIG. 5, the second depth image may be processed at 330. In one embodiment, the target recognition, analysis, and tracking system may process the second depth image, at 330, such that a model of a human target in the captured scene may be generated. According to an example embodiment, the model may be tracked, an avatar associated with the model may be rendered, and/or one or more applications executing on a computer environment may be controlled.

For example, according to an example embodiment, a model such as a skeletal model, a mesh human model, or the like of the user 18 described above with respect to FIGS. 1A and 1B may generated by processing the second depth image at 330.

In one embodiment, the model may be generated by the capture device and provided to a computing environment such as the computing environment 12 described above with respect to FIGS. 1A-4. The computing environment may include a gestures library that may be used to determine controls to perform within an application based on positions of various body parts in the skeletal model.

The visual appearance of an on-screen character may then be changed in response to changes to the model being tracked. For example, a user such as the user 18 described above with respect to FIGS. 1A and 1B playing an electronic game on a gaming console may be tracked by the gaming console as described herein. In particular, a body model such as a skeletal model may be used to model the target game player, and the body model may be used to render an on-screen player avatar. As the game player straightens one arm, the gaming console may track this motion, then in response to the tracked motion, adjust the body model accordingly. The gaming console may also apply one or more constraints to movements of the body model. Upon making such adjustments and applying such constraints, the gaming console may display the adjusted player avatar.

In one embodiment, the target recognition, analysis, and tracking system may not be able to process the second depth image at 330. For example, the depth image may be too noisy or include too may empty pixels such that the depth image may not be processed. According to one embodiment, if the depth values may be too noisy, the target recognition, analysis, and tracking system may generate an error message that may be provided to a user such as the user 18 described above with respect to FIGS. 1A and 1B to indicate that another scene may need to be captured.

It should be understood that the configurations and/or approaches described herein are exemplary in nature, and that these specific embodiments or examples are not to be considered limiting. The specific routines or methods described herein may represent one or more of any number of processing strategies. As such, various acts illustrated may be performed in the sequence illustrated, in other sequences, in parallel, or the like. Likewise, the order of the above-described processes may be changed.

Additionally, the subject matter of the present disclosure includes combinations and subcombinations of the various processes, systems and configurations, and other features, functions, acts, and/or properties disclosed herein, as well as equivalents thereof.

What is claimed:

1. A device for processing depth information of a scene, the device comprising:
a camera component, wherein the camera component receives a first depth image of the scene; and
a processor, wherein the processor executes computer executable instructions, and wherein the computer executable instructions comprise instructions for:
receiving the first depth image of the scene from the camera component;
estimating a depth value for one or more pixels associated with noise in the depth image; and
rendering a second depth image with the estimated depth value for the one or more pixels associated with the noise in the scene.

2. The device of claim 1, wherein the one or more pixels associated with noise in the depth image includes one or more pixels having a depth value of zero.

3. The device of claim 1, wherein the instructions for estimating the depth value for the one or more pixels associated with the noise in the first depth image comprise instructions for:
identifying a first pixel from the one or more of the pixels associated with the noise in the first depth image;
determining whether pixels adjacent to the first pixel have valid depth values; and
generating a depth value for the pixel based the valid depth values.

4. The device of claim 3, wherein the instructions for generating the depth value for the pixel based the valid depth values comprise instructions for:
identifying a second pixel adjacent to first pixel having the smallest, valid depth value and a third pixel adjacent to the first pixel having the largest, valid depth value;
determining a difference between the smallest, valid depth value and the largest, valid depth value; and
assigning the smallest, valid depth value to the depth value for the first pixel if, based on the determination, the difference is greater than a threshold value.

5. The device of claim 4, wherein the instructions for generating the depth value for the pixel based the valid depth values further comprise instructions for:
calculating an average depth value based on the valid depth values of the adjacent pixels if, based on the determination, the difference is less than a threshold value; and
assigning the average depth value to the depth value for the first pixel.

6. The device of claim 1, wherein the instructions for estimating the depth value for the one or more pixels associated with the noise in the first depth image comprise instructions for:
generating a noise severity value;
adjusting the noise severity value based on a growth value; and
determining whether to estimate the depth value for the one or more pixels associated the noise based on the adjusted growth value.

7. The device of claim 1, further comprising instructions for processing the second depth image.

8. The device of claim 7, wherein the instructions for processing the second depth image comprise instructions for:
determining whether the second depth image includes a human target; and
generating a model of the human target if, based on the determination, the second depth image includes the human target.

9. A computer-readable storage medium having stored thereon computer executable instructions for processing depth information of a captured scene, the computer executable instructions comprising instructions for:
receiving a first depth image of the scene, wherein the first depth image includes an empty pixel;
determining whether a first pixel adjacent to the empty pixel has a first valid depth value;
generating a depth value for the empty pixel based the first valid depth value if, based on the determination, the first pixel has a first valid depth value; and
rendering a second depth image with the generated depth value for the empty pixel.

10. The computer-readable storage medium of claim 9, further comprising instructions for determining whether a second pixel adjacent to the empty pixel has a second valid depth value, wherein the depth value for the empty pixel is generated based on the first and second valid depth values if, based on the determination, the second pixel has a second valid depth value.

11. The computer-readable storage medium of claim 10, wherein the instructions for generating the depth value for the pixel based the first and second valid depth values comprise instructions for:
determining whether the first and second valid depth values include a smallest depth value adjacent to the empty pixel and a largest depth value adjacent to the empty pixel;
calculating a difference between the first and second valid depth values if, based on the determination, the first and second valid depth values are the smallest depth value adjacent to the empty pixel and the largest depth value adjacent to the empty pixel;
assigning the smallest depth value to the depth value for the empty pixel if the difference is greater than a threshold value.

12. The computer-readable storage medium of claim 11, wherein the instructions for generating the depth value for the pixel based the first and second valid depth values further comprise instructions for:
calculating an average depth value based on at least the first and second valid depth values if the difference is less than the threshold value; and
assigning the average depth value to the depth value for the empty pixel.

13. The computer-readable storage medium of claim 9, further comprising instructions for:
generating a noise severity value;
adjusting the noise severity value based on a growth value; and
determining whether to estimate the depth value for the empty pixel based on the adjusted growth value.

14. The computer-readable storage medium of claim 9, further comprising instructions for processing the second depth image.

15. The computer-readable storage medium of claim 15, wherein the instructions for processing the second depth image comprise instructions for:
determining whether the second depth image includes a human target; and
generating a model of the human target if, based on the determination, the second depth image includes the human target.

16. A system for processing depth information of a scene; the system comprising:
a capture device, wherein the capture device comprises a camera component that receives a first depth image of a scene; and
a computing device in operative communication with the capture device, wherein the computing device comprises a processor that receives the first depth image of the scene from the capture device; determines whether the first depth image includes a hole having pixels without depth values; and estimates the depth values for the pixels if, based on the determination, the first depth image includes the hole.

17. The system of claim 16, wherein the processor estimates the depth value for the pixels by identifying a first pixel from the pixels associated with the hole in the first depth image; determining whether pixels adjacent to the first pixel have valid depth values; and generating a depth value for the first pixel based the valid depth values of the adjacent pixels.

18. The system of claim 16, wherein the processor further generates a noise severity value; adjusts the noise severity value based on a growth value; and determines whether to estimate the depth value for one of the pixels in the hole based on the adjusted growth value.

19. The system of claim 16, wherein the processor further renders a second depth image that includes the estimated depth values, determines whether the second depth image includes a human target, and generates a model of the human target if the second depth image includes the human target.

20. The system of claim 19, wherein the processor further tracks one or more movements of the model.

21. The system of claim 20, wherein the computing device further comprises a gestures library stored thereon, and wherein the processor compares the one or more tracked movements with the gestures library to determine whether to perform a control to perform based on the one or more movements.
